(19) United States
(12) Patent Application Publication
(10) Pub. No.: US 2025/0043694 A1
(43) Pub. Date: Feb. 6, 2025

(54) VIBRATIONAL DAMPING ASSEMBLY FOR A TURBOMACHINE EXHAUST DIFFUSER

(71) Applicant: GE Infrastructure Technology LLC, Greenville, SC (US)

(72) Inventors: Robert Jamiolkowski, Warszawa (PL); Tobias Leuenberger, Baden (CH); Adam Wisniewski, Warszawa (PL)

(21) Appl. No.: 18/785,996

(22) Filed: Jul. 26, 2024

(30) Foreign Application Priority Data
Aug. 1, 2023 (PL) P.445726

(51) Int. Cl. F01D 25/04; F01D 9/02

(52) U.S. Cl. CPC F01D 25/04; F01D 9/02; F05D 2220/32; F05D 2240/127; F05D 2260/96

(57) ABSTRACT

A vibrational damping assembly affixed to a turbomachine component. The vibrational damping assembly includes at least one pin assembly coupled to the turbomachine component. The at least one pin having a pin body and a disk coupled to the pin body. The vibrational damping assembly further includes at least one plate disposed between the disk and the turbomachine component. The at least one plate surrounds the at least one pin. The at least one plate is movable between the disk and the turbomachine component relative to the at least one pin and relative to the turbomachine component to dampen vibrations experienced by the turbomachine component.

### CROSS-REFERENCE TO RELATED APPLICATIONS

This application claims priority pursuant to 35 U.S.C. 119 (a) to Polish Application No. P.445726, filed Aug. 1, 2023, which application is incorporated herein by reference in its entirety.

### FIELD

The present disclosure relates generally to vibrational mitigation in an exhaust diffuser of a turbomachine. Specifically, the present disclosure is related to an apparatus for mitigating frequency oscillations in the turbomachine exhaust diffuser.

### BACKGROUND

Turbomachines are utilized in a variety of industries and applications for energy transfer purposes. For example, a gas turbine engine generally includes a compressor section, a combustion section, a turbine section, and an exhaust section. The compressor section progressively increases the pressure of a working fluid entering the gas turbine engine and supplies this compressed working fluid to the combustion section. The compressed working fluid and a fuel (e.g., natural gas) mix within the combustion section and burn in a combustion chamber to generate high pressure and high temperature combustion gases. The combustion gases flow from the combustion section into the turbine section where they expand to produce work. For example, expansion of the combustion gases in the turbine section may rotate a rotor shaft connected, e.g., to a generator to produce electricity. The combustion gases are then exhausted from the turbine section through an exhaust diffuser positioned downstream from the turbine section.

The exhaust diffuser typically includes an inner liner and an outer liner that is radially separated from the inner liner to form an exhaust flow passage through the diffuser. One or more generally airfoil shaped diffuser struts extend between the inner and outer liners within the exhaust flow passage to provide structural support to the outer liner and/or to an aft bearing that supports the shaft.

Typical power generating turbomachines are capable of enormous power output, and as such, are often operated at part or partial load to satisfy demand. However, operating at part or partial load can result in frequency oscillations (i.e., pressure pulsations or vibrations) within the exhaust diffuser that could cause damage over time or result in an unscheduled or premature shutdown of the turbomachine.

Accordingly, a vibrational damping assembly, that reduces or eliminates mechanical vibrations experienced by the exhaust diffuser, is desired and would be appreciated in the art.

### BRIEF DESCRIPTION

Aspects and advantages of the present exhaust diffuser assemblies and vibrational damping assemblies in accordance with the present disclosure will be set forth in part in the following description, or may be obvious from the description, or may be learned through practice of the technology.

In accordance with one embodiment, an exhaust diffuser assembly for a turbomachine is provided. The exhaust diffuser includes an inner liner, an outer liner spaced apart from the inner liner such that an exhaust flow passage is defined therebetween, and a plurality of struts disposed within the exhaust flow passage and extending between the inner liner and the outer liner. The exhaust diffuser assembly further includes one or more vibrational damping assemblies affixed to the exhaust diffuser on at least one of the inner liner, the outer liner, and at least one strut of the plurality of struts each vibrational damping assembly of the plurality of vibrational damping assemblies includes: at least one pin assembly coupled to the exhaust diffuser, the at least one pin assembly having a pin body and a disk coupled to the pin body. The at least one pin assembly further includes at least one plate disposed between the disk and the exhaust diffuser. The at least one plate surrounds the at least one pin. The at least one plate is movable between the disk and the exhaust diffuser relative to the pin body and relative to the exhaust diffuser.

In accordance with another embodiment, a vibrational damping assembly affixed to a turbomachine component is provided. The vibrational damping assembly includes at least one pin assembly coupled to the turbomachine component. The at least one pin having a pin body and a disk coupled to the pin body. The vibrational damping assembly further includes at least one plate disposed between the disk and the turbomachine component. The at least one plate surrounds the at least one pin. The at least one plate is movable between the disk and the turbomachine component relative to the at least one pin and relative to the turbomachine component to dampen vibrations experienced by the turbomachine component.

These and other features, aspects and advantages of the present exhaust diffuser assemblies and vibrational damping assemblies will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present exhaust diffuser assemblies and vibrational damping assemblies, including the best mode of making and using the present systems and methods, directed to one of ordinary skill in the art, is set forth in the specification, which makes reference to the appended figures, in which:

FIG. 1 is a schematic illustration of a turbomachine in accordance with embodiments of the present disclosure;

FIG. 2 illustrates an enlarged cross-sectional view of an exhaust diffuser assembly in accordance with embodiments of the present disclosure;

FIG. 3 illustrates a cross-sectional view of the exhaust diffuser assembly from along the line 3-3 shown in FIG. 2, in accordance with embodiments of the present disclosure in accordance with embodiments of the present disclosure;

FIG. 4 illustrates an isometric view of an exhaust diffuser assembly having an exhaust diffuser with a plurality of vibrational damping assemblies coupled thereto in accordance with embodiments of the present disclosure;

FIG. 5 illustrates an enlarged plan view of the exhaust diffuser assembly shown in FIG. 4 in accordance with embodiments of the present disclosure;

FIG. 6 schematically illustrates a cross-sectional view of the exhaust diffuser assembly 100 from along the line 6-6 shown in FIG. 5, in accordance with embodiments of the present disclosure;

FIG. 7 illustrates a cross-sectional view of an exhaust diffuser assembly, which depicts details of a floating pin assembly in accordance with embodiments of the present disclosure; and

FIG. 8 illustrates a cross-sectional view of an exhaust diffuser assembly, which shows details of a positioning pin assembly in accordance with embodiments of the present disclosure.

### DETAILED DESCRIPTION

Reference now will be made in detail to embodiments of the present exhaust diffuser assemblies and vibrational damping assemblies, one or more examples of which are illustrated in the drawings. Each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components.

The term “fluid” may be a gas or a liquid. The term “fluid communication” means that two or more areas defining a flow passage are joined to one another such that a fluid is capable of making the connection between the areas specified.

As used herein, the terms “upstream” (or “forward”) and “downstream” (or “aft”) refer to the relative direction with respect to fluid flow in a fluid pathway. For example, “upstream” refers to the direction from which the fluid flows, and “downstream” refers to the direction to which the fluid flows. However, the terms “upstream” and “downstream” as used herein may also refer to a flow of electricity. The term “radially” refers to the relative direction that is substantially perpendicular to an axial centerline of a particular component; the term “axially” refers to the relative direction that is substantially parallel and/or coaxially aligned to an axial centerline of a particular component; and the term “circumferentially” refers to the relative direction that extends around the axial centerline of a particular component.

Terms of approximation, such as “about,” “approximately,” “generally,” and “substantially,” are not to be limited to the precise value specified. In at least some instances, the approximating language may correspond to the precision of an instrument for measuring the value, or the precision of the methods or machines for constructing or manufacturing the components and/or systems. In at least some instances, the approximating language may correspond to the precision of an instrument for measuring the value, or the precision of the methods or machines for constructing or manufacturing the components and/or systems. For example, the approximating language may refer to being within a 1, 2, 4, 5, 10, 15, or 20 percent margin in either individual values, range(s) of values and/or endpoints defining range(s) of values. When used in the context of an angle or direction, such terms include within ten degrees greater or less than the stated angle or direction. For example, “generally vertical” includes directions within ten degrees of vertical in any direction, e.g., clockwise or counter-clockwise.

The terms “coupled,” “fixed,” “attached to,” and the like refer to both direct coupling, fixing, or attaching, as well as indirect coupling, fixing, or attaching through one or more intermediate components or features, unless otherwise specified herein. The terms “directly coupled,” “directly fixed,” “directly attached to,” and the like mean that two components are joined in contact with one another and that no intermediate components or features are present.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “and/or” refers to a condition satisfied by any one of the following: A is true (or present) and B is false (or not present), A is false (or not present) and B is true (or present), and both A and B are true (or present).

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

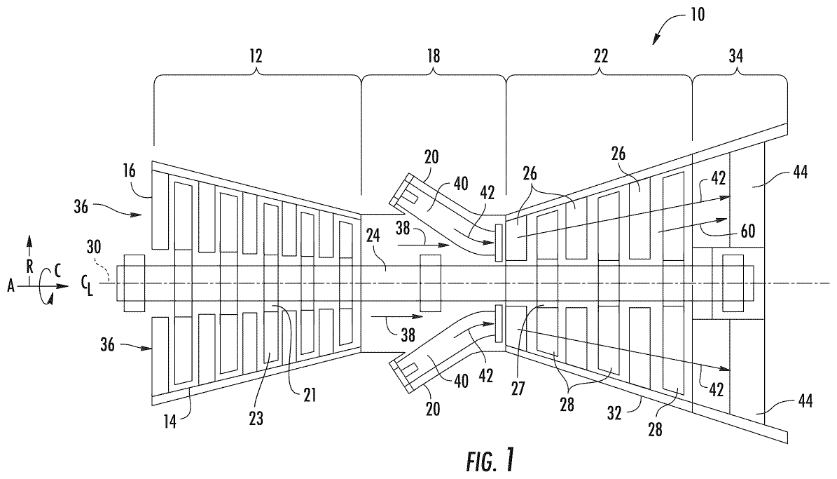

Referring now to the drawings, FIG. 1 illustrates a schematic diagram of one embodiment of a turbomachine, which in the illustrated embodiment is a gas turbine engine 10. Although an industrial or land-based gas turbine engine is shown and described herein, the present disclosure is not limited to a land-based and/or industrial gas turbine engine, unless otherwise specified in the claims. For example, the invention as described herein may be used in any type of turbomachine including but not limited to a steam turbine, an aircraft gas turbine, or a marine gas turbine.

As shown, the gas turbine engine 10 generally includes a compressor section 12. The compressor section 12 includes a compressor 14. The compressor section 12 includes an inlet 16 that is disposed at an upstream end of the gas turbine engine 10. The gas turbine engine 10 further includes a combustion section 18 having one or more combustors 20 disposed downstream from the compressor section 12. The gas turbine engine 10 further includes a turbine section 22 that is downstream from the combustion section 18. A shaft 24 extends generally axially through the gas turbine engine 10.

The compressor section 12 may generally include a plurality of rotor disks 21 and a plurality of rotor blades 23 extending radially outwardly from and connected to each rotor disk 21. Each rotor disk 21 in turn may be coupled to or form a portion of the shaft 24 that extends through the compressor section 12. The rotor blades 23 of the compressor section 12 may include turbomachine airfoils that define an airfoil shape (e.g., having a leading edge, a trailing edge, and side walls extending between the leading edge and the trailing edge). Additionally, the compressor section 12 includes stator vanes disposed between the rotor blades to define a series of compression stages. The stator vanes may extend from, and couple to, a compressor casing.

The turbine section 22 may generally include a plurality of rotor disks 27 and a plurality of rotor blades 28 extending radially outwardly from and being interconnected to each rotor disk 27. Each rotor disk 27 in turn may be coupled to or form a portion of the shaft 24 that extends through the turbine section 22. The turbine section 22 further includes an outer casing 32 that circumferentially surrounds the portion of the shaft 24 and the rotor blades 28. The turbine section 22 may include stationary nozzles 26 extending radially inward from the outer casing 32. The rotor blades 28 and stationary nozzles 26 may be arranged in alternating fashion in stages along an axial centerline 30 of gas turbine 10. Both the rotor blades 28 and the stationary nozzles 26 may include turbomachine airfoils that define an airfoil shape (e.g., having a leading edge, a trailing edge, and side walls extending between the leading edge and the trailing edge).

In operation, ambient air 36 or other working fluid is drawn into the inlet 16 of the compressor 14 and is progressively compressed to provide a compressed air 38 to the combustion section 18. The compressed air 38 flows into the combustion section 18 and is mixed with fuel to form a combustible mixture. The combustible mixture is burned within a combustion chamber 40 of the combustor 20, thereby generating combustion gases 42 that flow from the combustion chamber 40 into the turbine section 22. Energy (kinetic and/or thermal) is transferred from the combustion gases 42 to the rotor blades 28, causing the shaft 24 to rotate and produce mechanical work.

The gas turbine engine 10 may define a cylindrical coordinate system having an axial direction A extending along the axial centerline 30, a radial direction R perpendicular to the axial centerline 30, and a circumferential direction C extending around the axial centerline 30.

The combustion gases 42 exit the turbine section 22 and flow through the exhaust diffuser 34 across a plurality of struts 44 that are disposed within the exhaust diffuser 34. During various operating conditions of the gas turbine engine 10, such as during part-load operation, the combustion gases 42 flowing into the exhaust diffuser 34 from the turbine section 22 are conferred with a high level of swirl that is caused by the rotating turbine rotor blades 28. Such swirling flow can cause pressure fluctuations, frequency oscillations, or acoustic vibrations.

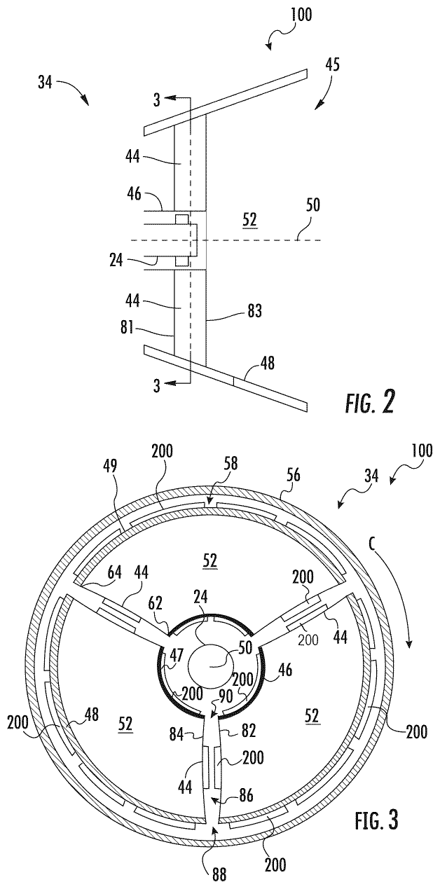

FIG. 2 illustrates a cross-sectional view of an exhaust diffuser assembly 100 (which includes an exhaust diffuser 34), and FIG. 3 illustrates a cross-sectional view of the exhaust diffuser assembly 100 from along the line 3-3 shown in FIG. 2, in accordance with embodiments of the present disclosure. As shown, the exhaust diffuser 34 generally includes an inner liner 46 and an outer liner 48 radially spaced apart from the inner liner 46. The inner liner 46 may extend generally axially along an axial centerline 50 of the exhaust diffuser 34. The axial centerline 50 of the exhaust diffuser 34 may be coaxial with the axial centerline 30 of the gas turbine engine 10. The inner liner 46 is generally annular shaped and may at least partially surround rotating components. For example, the inner liner 46 may surround or encase a portion of the shaft 24.

In many embodiments, the outer liner 48 may be radially separated from the inner liner 46, such that an exhaust flow passage 52 is defined between the inner liner 46 and the outer liner 48. In particular embodiments, the inner liner 46 is concentrically and coaxially aligned within the outer liner 48 with respect to the axial centerline 50. In certain embodiments, an outer casing 56 may annularly surround the outer liner 48 such that a fluid plenum 58 is defined between the outer casing 56 and the outer liner 48. A flow of compressed air (or other working fluid) may flow within the fluid plenum 58 to cool the various components of the exhaust diffuser 34 (such as the outer liner 48 and the struts 44). The present disclosure is not limited to any particular size, shape, material, or other physical characteristics of the inner liner 46, the outer liner 48, and/or the outer casing 56, except as recited in the claims.

Each of the diffuser struts 44 may extend between the inner liner 46 and the outer liner 48 and within the exhaust flow passage 52 defined therebetween. The diffuser struts 44 are spaced circumferentially around the inner liner 46, and the diffuser struts 44 may orient, align, or otherwise center the inner liner 46 within the outer liner 48. In addition, the diffuser struts 44 may provide structural support between the inner and the outer liners 46, 48. As shown in FIG. 1, the diffuser struts 44 are positioned relative to a direction of flow 60 of the spent combustion gases 42 flowing from the turbine section 22 of the gas turbine engine 10. As shown in FIG. 3, each diffuser strut 44 generally includes a root portion 62 that is connected to the inner liner 46, and a tip portion 64 radially separated from the root portion 62 and connected to the outer liner 48.

In exemplary embodiments, as shown in FIG. 3, the exhaust diffuser assembly 100 may further include one or more vibrational damping assemblies 200 affixed to the exhaust diffuser 34 on at least one of the inner liner 46, the outer liner 48, and at least one strut 44 of the plurality of struts 44. Particularly, as shown, a plurality of vibrational damping assemblies 200 may be affixed to the inner liner 46, a plurality of vibrational damping assemblies 200 may be affixed to the outer liner 48, and one or more vibrational damping assemblies may be affixed to each strut 44 of the plurality of struts 44. Each of the vibrational damping assemblies 200 may be positioned outside of the exhaust flow passage 52.

In exemplary embodiments, the one or more vibrational damping assemblies 200 includes a plurality of vibrational damping assemblies 200 circumferentially spaced apart from one another and affixed to at least one of the outer liner 48 and/or the inner liner 46 outside of the exhaust flow passage 52. For example, one or more vibrational damping assemblies 200 may be affixed to a radially outer surface 49 of the outer liner 48 and disposed within the fluid plenum 58 (e.g., radially between the outer liner 48 and the outer casing 56). In this way, the one or more vibrational damping assemblies 200 affixed to the outer liner 48 may be disposed between (e.g., radially between) the outer liner 48 and the outer casing 56. The one or more vibrational damping assemblies 200 may be radially spaced apart from the outer casing 56 (such that the vibrational damping assemblies 200 do not contact the outer casing 56).

Additionally, or alternatively, one or more vibrational damping assemblies 200 may be affixed to a radially inner surface 47 of the inner liner 46. The one or more vibrational damping assemblies 200 affixed to the inner liner 46 may be disposed between (e.g., radially between) the inner liner 46 and the shaft 24. The one or more vibrational damping assemblies 200 affixed to the inner liner 46 may be radially spaced apart from the shaft 24 (such that the vibrational damping assemblies 200 do not contact the shaft 24).

In some embodiments, as shown, one or more vibrational damping assemblies 200 may be disposed within the strut 44. For example, the strut 44 may include a leading edge 81 (FIG. 2), a trailing edge 83 (FIG. 2), a first side wall 82, and a second side wall 84, which may collectively define an interior 86 of the strut 44. One or more vibrational damping assemblies 200 may be disposed within the interior 86 of the strut 44. For example, the vibrational damping assembly 200 may be coupled (or affixed) to one of the first side wall 82 and/or the second side wall 84 within the interior 86.

While FIG. 3 illustrates a vibrational damping assembly 200 affixed to the inner liner 46, the outer liner 48, and the struts 44, it should be appreciated that the vibrational damping assembly 200 may be coupled to any component of the gas turbine engine 10 (i.e., “turbomachine component”) to dampen vibrations experienced by said component. In certain embodiments, the vibrational damping assembly 200 may be coupled to a turbomachine airfoil, such as an airfoil in the compressor section 12 (e.g., an airfoil of the compressor rotor blades and/or the stator vanes), or such as an airfoil in the turbine section 22 (e.g., an airfoil of the turbine rotor blades and/or turbine nozzles). However, in exemplary embodiments, as shown in FIG. 3, the vibrational damping assembly 200 may be coupled to the various components of the exhaust diffuser 34 (such as the inner liner 46, the outer liner 48, and the struts 44) in order to dampen vibrations experienced by the exhaust diffuser 34.

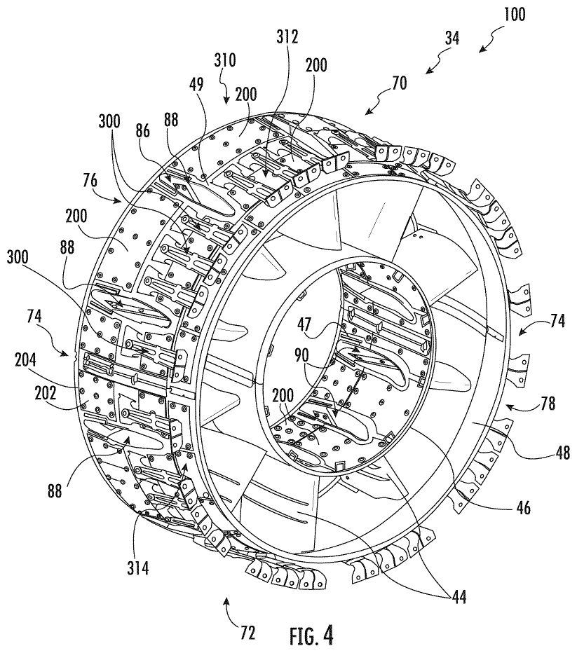

FIG. 4 illustrates an isometric view of an exhaust diffuser assembly 100 having an exhaust diffuser 34 with a plurality of vibrational damping assemblies 200 coupled thereto. As discussed above, the exhaust diffuser 34 may include an inner liner 46, an outer liner 48, and a plurality of struts 44 extending between (e.g., radially) the inner liner 46 and the outer liner 48. The exhaust diffuser 34 may include a top half 70 and a bottom half 72, which are joined together at a split line 74. Additionally, the exhaust diffuser 34 may extend axially between a forward end 78 and an aft end 76.

As shown in FIG. 4, the plurality of vibrational damping assemblies 200 that are affixed to the outer liner 48 may be arranged in in a forward group 314, one or more intermediate groups 312 (one intermediate group 312 is shown in FIG. 4), and an aft group 310. The forward group 314, the one or more intermediate groups 312, and the aft group 310 may be axially staggered (or offset) from one another, such that the groups 310, 312, 314 do not axially overlap. The forward group 314 may be positioned closest to the forward end 78 of the exhaust diffuser 34. The one or more intermediate groups 312 may be positioned axially between the forward group 314 and the aft group 310. The aft group 310 may be positioned closest to the aft end 76. Similarly, as shown, the plurality of vibrational damping assemblies 200 that are affixed to the inner liner 46 may be arranged in a forward group and an aft group.

As shown in FIGS. 3 and 4, each strut 44 of the plurality of struts 44 defines an interior 86 that extends between an outer opening 88 defined in the outer liner 48 and an inner opening 90 defined in the inner liner 46. In such embodiments, one or more vibrational damping assemblies 200 that are affixed to the outer liner 48 may be disposed between circumferentially neighboring outer openings 88. Particularly, the aft group 310 and the one or more intermediate groups 312 may be disposed circumferentially between two neighboring outer openings 88. The forward group 314 may be disposed forward of the outer openings 88. Similarly, one or more vibrational damping assemblies 200 that are affixed to the inner liner 46 may be disposed between circumferentially neighboring inner openings 90.

In many embodiments, the exhaust diffuser 34 may further include a plurality of support links 300 coupled to an outer surface 49 of the outer liner 48. The plurality of support links 300 may be circumferentially spaced apart from one another (e.g., equally spaced apart in some instances and/or unequally spaced apart in other instances). The plurality of support links 300 may be positioned forward of the aft group 310 of vibrational damping assemblies 200 affixed to the outer liner 48. For example, a single split-line support link 300 may be disposed between the split line 74 and an outer opening 88, and the vibrational damping assembly 200 may be sized to fit within the circumferential dimension between the outer opening 88 and the split line 74. A group of equally spaced support links 300 (e.g., a group of three support links) may be disposed circumferentially between two outer openings 88. As shown in FIG. 5, each support link 300 may include a main body 302 coupled to an outer surface 49 of the outer liner 48 (e.g., via one or more fasteners) and a flange portion 304 extending radially outwardly from the main body 302. One or more vibrational damping assemblies 200 may be positioned between (e.g., radially between) the outer liner 48 and one or more support links 300. For example, one or more support links 300 may axially overlap, and be positioned radially outwardly from, the vibrational damping assemblies 200 in the one or more intermediate groups 312 and the forward group 314.

FIG. 5 illustrates an enlarged plan view of the exhaust diffuser assembly 100 in accordance with embodiments of the present disclosure. As shown, the vibrational damping assembly 200 may include at least one plate 202 and at least one pin assembly 204 extending through the at least one plate 202. For example, the at least one plate 202 may surround the at least one pin assembly 204. Particularly, the vibrational damping assembly 200 may include a plurality of pin assemblies 204 coupled to the exhaust diffuser 34 (e.g., coupled to one of the outer liner 48, the inner liner 46, or the struts 44) and each extending through the at least one plate 202. In various embodiments, the at least one plate 202 may be composed of metal (e.g., sheet metal) or other suitable materials.

As shown, the plurality of pin assemblies 204 coupled to the plate 202 of each vibrational damping assembly 200 may be arranged in an array. In other words, the plurality of pin assemblies 204 may be arranged in an array (e.g., a pattern) on the exhaust diffuser 34. The plurality of pin assemblies 204 may be arranged in one or more rows, with each row being aligned along a common axis, such as aligned along a circumferential axis 206, an axial axis 208, a radial axis (not shown), or another axis that does not correspond with the axial, conferential, or radial directions. Each pin assembly 204 may be spaced apart from neighboring pin assemblies 204 in the plurality of pin assemblies 204.

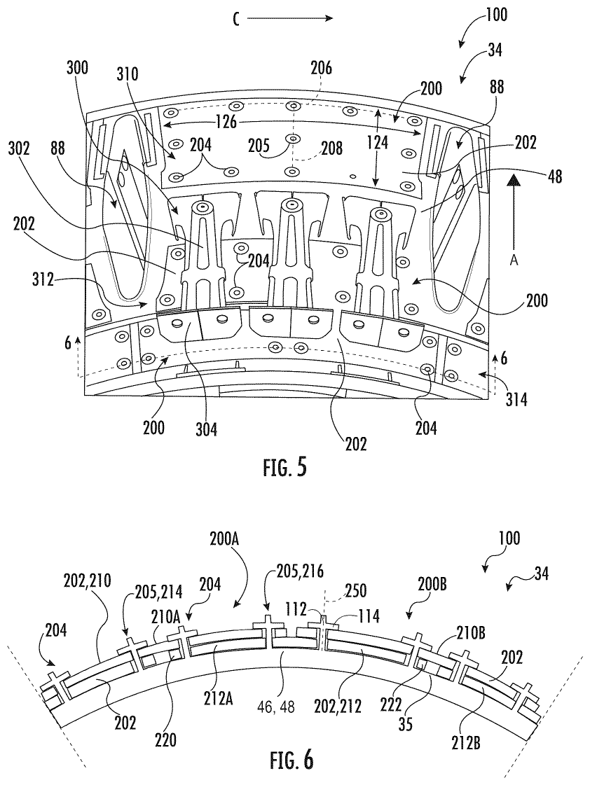

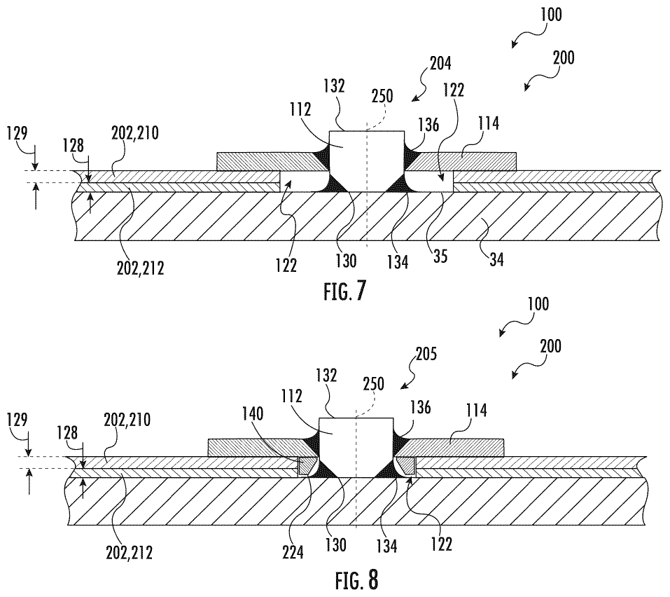

In exemplary embodiments, the plurality of pin assemblies 204 for each vibrational damping assembly 200 may include at least one positioning pin assembly 205. Each pin assembly 204, 205 includes a pin body 112 that is installed in an opening in the at least one plate 202 of the vibrational damping assembly 200 and a disk 114 that secures the at least one plate 202 in position against the respective surface of the exhaust diffuser 34. As will be explained below in further detail, the positioning pin assembly 205 may ensure the at least one plate 202 does not shift in directions orthogonal to the longitudinal axis of the pin body 112 (FIGS. 6 and 7), such that the at least one plate 202 is constrained to movement in a direction parallel to a longitudinal axis of the pin body 112 between the disk 114 and the exhaust diffuser 34. In exemplary embodiments, the positioning pin 205 may be disposed towards the center of the plate 202.

As shown in FIG. 5, the at least one plate 202 may define a width 124, a length 126, and a thickness 128, 129 (FIGS. 7 and 8). The length 126 may longer than the width 124 and the thickness 128, 129 (i.e., the length 126 is the longest dimension of the plate 202). The thickness 128, 129 may be smaller than the length 126 and the width 124 (i.e., the thickness 128, 129 is the smallest dimension of the plate 202). A surface area of the plate 202 may be calculated by multiplying the width 124 by the length 126. In exemplary embodiments, the least one plate 202 is thin walled such that the at least one plate 202 defines a ratio between a thickness 128, 129 of the at least one plate 202 and a width 124 of the at least one plate 202 of between about 1:100 and about 1:5000, or such as between about 1:500 and about 1:4500, or such as between about 1:1000 and about 1:4000, or such as between about 1:1500 and about 1:3500, or such as between about 1:2000 and about 1:3000. In many embodiments, the surface area of the at least one plate 202 may be between about 0.02 m2 and about 2 m2, or such as between about 0.12 m2 and about 1.9 m2, or such as between about 0.22 m2 and about 1.8 m2, or such as between about 0.32 m2 and about 1.7 m2, or such as between about 0.42 m2 and about 1.6 m2, or such as between about 0.52 m2 and about 1.5 m2, or such as between about 0.82 m2 and about 1.2 m2.

FIG. 6 illustrates a cross-sectional view of the exhaust diffuser assembly 100 from along the line 6-6 shown in FIG. 5, in accordance with embodiments of the present disclosure. As shown, each of the pins 204 may include a pin body 112 and a disk 114 coupled to the pin body 112. The pin body 112 may extend from the exhaust diffuser 34. For example, in FIG. 5, the pin body may extend from the outer surface 49 of the outer liner 48. In exemplary embodiments, as shown, the at least one plate 202 may include two or more plates 202 disposed between the disk 114 and the exhaust diffuser 34. In such embodiments, the least one plate 202 may include an outer plate 210 (e.g., a radially outer plate) and an inner plate 212 (e.g., a radially inner plate). The inner plate 212 may be disposed radially between the exhaust diffuser 34 and the outer plate 210. The outer plate 210 may be disposed radially between the inner plate 212 and the disk 114. The at least one plate 202, including the inner plate 212 and the outer plate 210, may be movable relative to the at least one pin 204 and relative to the exhaust diffuser 34 to dampen vibrations experienced by the exhaust diffuser 34 during operation of the gas turbine engine 10.

As shown in FIGS. 6 through 8, each plate 202 may define a plurality of apertures 122, which may be concentric and aligned with one another, such that a passage is defined collectively by the apertures 122 of each plate 202. Each pin body 212 in the at least one pin assembly 204, 205 may extend through a respective aperture 122 of the plurality of apertures 122. Particularly, the pin body 112 of each pin assembly 204, 205 may extend through the aperture 122 of the inner plate 212 and the aperture 122 of the outer plate 212 (thereby extending through the passage). A diameter of the disk 114 may be larger than a diameter of the aperture 122, such that the plates 202 do not fall off the pin bodies 112 during installation or operation. Similarly, a diameter of the pin body 112 is smaller than the diameter of the apertures 122, such that the pin body 112 may extend through the apertures 122.

The pin body 112 of each pin assembly 204, 205 may extend along a longitudinal axis 250 (which may extend generally perpendicularly from the exhaust diffuser 34), and the at least one plate 202 may be constrained to movement along the longitudinal axis 250 to dampen vibrations experienced by the exhaust diffuser. This limited motion is facilitated by the positioning pin assembly 205, which may have different structure than the other pin assemblies 204 (as discussed below), and which may contact the one or more plates 202 to constrain their movement to one direction. In the embodiment shown in FIG. 6, the vibrational damping assembly 200 may include one or more outer positioning pin assemblies 214 and one or more inner positioning pin assemblies 216. For each outer positioning pin assembly 214, the aperture 122 in the outer plate 210 through which the outer positioning pin body 112 extends may be sized such that the outer plate 210 forms surrounding frictional contact with the outer positioning pin body 112, thereby restraining movement of the outer plate 210 to a direction parallel to the longitudinal axis 250. Similarly, for each inner positioning pin assembly 216, the aperture 122 in the inner plate 212 through which the inner positioning pin body 112 extends may be sized such that the inner plate 212 forms surrounding frictional contact with the inner positioning pin body 112, thereby restraining movement of the inner plate to a direction parallel to the longitudinal axis 250.

In many embodiments, the outer plate 210 may be offset (e.g., axially offset and/or circumferentially offset) from the inner plate 212 such that the inner plate 212 and the outer plate 210 partially overlap. In exemplary embodiments, the outer plate 210 may be circumferentially offset from the inner plate 212 such that the inner plate 212 and the outer plate 210 partially overlap. In such embodiments, a portion of the inner plate 212 may extend circumferentially beyond a terminal end of the outer plate 210 on a first side of the vibrational damping assembly 200, and a portion of the outer plate 210 may extend circumferentially beyond a terminal end of the inner plate on a second side of the vibrational damping assembly 200 (the second side being opposite the first side).

As shown in FIG. 6, the plurality of vibrational damping assemblies 200 may include a first vibrational damping assembly 200A and a second vibrational damping assembly 200B neighboring one another (e.g., circumferentially neighboring one another). The first vibrational damping assembly 200A includes a first outer plate 210A and a first inner plate 212A, and the second vibrational damping assembly 200B includes a second outer plate 210B and a second inner plate 212B. The first inner plate 212A may be offset from the first outer plate 210A and contact the first outer plate 210A and the second outer plate 210B. The first inner plate 212A may extend from a first end 220 that is overlapped by (and contacts) the first outer plate 210A to a second end 222 that is overlapped by (and contacts) the second outer plate 210B.

FIG. 7 illustrates a cross-sectional view of an exhaust diffuser assembly 100, which shows details of a pin assembly 204 (e.g., a floating pin assembly) in accordance with embodiments of the present disclosure. As shown, the pin assembly 204 includes the pin body 112 coupled to a surface 35 of the exhaust diffuser 34. The surface 35 of the exhaust diffuser 34 may be the radially inner surface of the inner liner 46 or the radially outer surface of the outer liner 48. For example, the pin body 112 may extend along a longitudinal centerline 250 from a base 130 coupled to the surface 35 of the exhaust diffuser 34 to a tip 132. The pin body 112 may be generally cylindrically shaped, and the pin body 112 may terminate at the tip 132. The base 130 of the pin body 112 may be fixedly coupled to the surface 35 via welding, such that a weld seam or fillet 134 is defined annularly around the base 130 of the pin body 112, thereby joining the pin body 112 to the surface 35.

The pin assembly 204 may further include a disk 114 that annularly surrounds the pin body 112. The disk 114 may be coupled to the pin body 112 between the base 130 and the tip 132. In various embodiments, the disk 114 may be fixedly coupled to the pin body 112 via welding, such that a weld seam or fillet 136 is defined annularly around the pin body 112, thereby joining the pin body 112 to the disk 114. Alternately, the pin body 112 may include a threaded tip 132, and the disk 114 may be threadingly coupled to the tip 132 and, optionally, further secured by welding or brazing.

In exemplary embodiments, as shown in FIG. 7, the at least one plate 202 may be at least two plates 202 disposed between the disk 202 and the surface 35. While FIGS. 7 and 8 illustrate an embodiment having two plates 202, it should be appreciated that the vibrational damping assembly 200 may include any number of plates 202 and should not be limited to any particular number of plates unless specifically recited in the claims. The at least two plates 202 may include an inner plate 212 and an outer plate 210.

As shown in FIG. 7, each plate 202 of the at least two plurality of plates 202 may define an aperture 122, which may be concentric and aligned with one another, such that a passage is defined collectively by the apertures 122 of each plate 202. The pin body 112 may extend through each aperture 122 (thereby extending through the passage). A diameter of the disk 114 may be larger than a diameter of the aperture 122, such that the plates 202 do not fall off the pin bodies 112 during installation or operation. Similarly, a diameter of the pin body 112 is smaller than the diameter of the aperture 122, such that the pin body 112 may extend through the apertures 122.

In exemplary embodiments, the plates 202 may include a first plate (such as the inner plate 212) having a first thickness 128 and a second plate (such as the outer plate 210) having a second thickness 129. The second thickness 129 may be greater than the first thickness 128. For example, the second thickness 129 may be between about 20% and about 80% greater than the first thickness 128, or such as between about 30% and about 70% greater than the first thickness 128, or such as between about 40% and about 60% greater than the first thickness 128. In many embodiments, a total thickness of the one or more panels 202 (such as a sum of the first thickness 128 and the second thickness 129) may be between about 20% and about 100% of a wall thickness of a wall (inner liner 46 or outer liner 48) to which the vibrational damping assembly 200 is attached. In exemplary embodiments, the total thickness of the one or more panels 202 may be between about 40% and about 60% of a wall thickness of a wall to which the vibrational damping assembly 200 is attached, which advantageously provides for the maximum damping effectiveness to the wall on which the vibrational damping assembly 200 is affixed.

In exemplary embodiments, each plate 202 of the two or more plates 202 may be movable between the disk 114 and the surface 35 relative to the pin body 112, the disk 114, the exhaust diffuser 34, and relative to the other plate(s) in the two or more plates 202 to dampen vibrations experienced by the exhaust diffuser 34. For example, each plate 202 may be constrained to movement in a direction parallel to a longitudinal axis 250 of the pin body 112 between the disk 114 and the surface 35. In various embodiments, a gap (not shown) may be defined between the disk 114 and the plurality of plates 202, such that the plurality of plates 202 are movable across the gap. For example, the distance between an inner surface of the disk 114 and the surface 35 may be slightly larger (e.g., between 0.01% and about 5% larger) than the sum of the first thickness 128 and the second thickness 129, such that a micro-gap may be defined between the disk 114 and the outer plate 210. In this way, the two or more plates 202 may move in a direction parallel to the longitudinal centerline 250 of the pin body 112 between the disk 114 and the surface 35 to dampen vibrations of the exhaust diffuser 34.

FIG. 8 illustrates a cross-sectional view of an exhaust diffuser assembly 100, which shows details of a positioning pin assembly 205 in accordance with embodiments of the present disclosure. As shown, the positioning pin assembly 205 may include an annular wall 140 extending from the disk 114 towards the surface 35 of the exhaust diffuser 34. The annular wall 140 may extend from the disk 114 of the positioning pin assembly 205 towards the surface 35 of the exhaust diffuser 34 to a free end 224. The free end 224 may be spaced apart from the surface 35 of the exhaust diffuser 34. In this way, the annular wall 140 may be cantilevered from the disk 114. The free end 224 may be spaced apart from the surface 35 of the exhaust diffuser 34 such that a gap is defined between the free end 224 and the surface 35 (i.e., the free end 224 does not contact the surface 35), which advantageously prevents wear and prolongs the life of the positioning pin 205. While the annular wall 140 is illustrated (e.g., by hatching in FIG. 8) as a separate element from the disk 114, it should be understood that the annular wall 140 and the disk 114 may be integrally formed.

The at least one plate 202 may contact the annular wall 140 of the positioning pin 205. For example, the diameter of the apertures 122 may be within about 5% of the outer diameter of the annular wall 140, such that the boundary defining the apertures 122 is in sliding contact with the exterior of the annular wall 140. In this way, the annular wall 140 may constrain the plurality of plates 202 to movement in a direction parallel to the to the longitudinal centerline 250 of the pin body 112. Moreover, by preventing the lateral motion of the plates 202, the annular wall 140 prevents the lateral motion of the plates 202 (e.g., in the circumferential direction), which might otherwise cause the base 130 of the pin body 112 to experience stress and lifecycle fatigue from repeated contact with the shifting plates 202.

During operation, the plates 202 may move relative to the disk 114, one another, and the exhaust diffuser 34, which causes micro-collisions (or “bumping”) between the plates 202. These micro-collisions may counteract vibrations experienced by the component to which the vibrational damping assembly 200 is attached, thereby advantageously increasing the hardware life of said component.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they include structural elements that do not differ from the literal language of the claims, or if they include equivalent structural elements with insubstantial differences from the literal language of the claims.

Further aspects of the invention are provided by the subject matter of the following clauses:

An exhaust diffuser assembly for a turbomachine, the exhaust diffuser assembly comprising: an exhaust diffuser having an inner liner, an outer liner spaced apart from the inner liner such that an exhaust flow passage is defined therebetween, and a plurality of struts disposed within the exhaust flow passage and extending between the inner liner and the outer liner; and one or more vibrational damping assemblies affixed to the exhaust diffuser on at least one of the inner liner, the outer liner, and at least one strut of the plurality of struts, wherein each vibrational damping assembly of the plurality of vibrational damping assemblies includes: at least one pin assembly coupled to the exhaust diffuser, the at least one pin assembly having a pin body and a disk coupled to the pin body; and at least one plate disposed between the disk and the exhaust diffuser, wherein the at least one plate surrounds the at least one pin, and wherein the at least one plate is movable between the disk and the exhaust diffuser relative to the pin body and relative to the exhaust diffuser to dampen vibrations experienced by the exhaust diffuser.

The exhaust diffuser assembly as in any preceding clause, wherein the one or more vibrational damping assemblies include a plurality of vibrational damping assemblies circumferentially spaced apart from one another and affixed to at least one of the outer liner and the inner liner outside of the exhaust flow passage.

The exhaust diffuser assembly as in any preceding clause, wherein each strut of the plurality of struts defines an interior extending between an outer opening defined in the outer liner and an inner opening defined in the inner liner, wherein at least one vibrational damping assembly is affixed to the outer liner and is disposed between circumferentially neighboring outer openings, and wherein at least one vibrational damping assembly is affixed to the inner liner and is disposed between circumferentially neighboring inner openings.

The exhaust diffuser assembly as in any preceding clause, wherein the at least one plate comprises an outer plate and an inner plate.

The exhaust diffuser assembly as in any preceding clause, wherein the outer plate is offset from the inner plate such that the inner plate and the outer plate partially overlap.

The exhaust diffuser assembly as in any preceding clause, the plurality of vibrational damping assemblies include a first vibrational damping assembly and a second vibrational damping assembly neighboring one another, wherein the first vibrational damping assembly includes a first outer plate and a first inner plate, wherein the second vibrational damping assembly includes a second outer plate and a second inner plate, and wherein the first inner plate is offset from the first outer plate and contacts the first outer plate and the second outer plate.

The exhaust diffuser assembly as in any preceding clause, wherein the at least one plate is thin walled such that the at least one plate defines a ratio between a thickness of the at least one plate and a width of the at least one plate of between about 1:100 and 1:5000.

The exhaust diffuser assembly as in any preceding clause, wherein the at least one plate comprises two or more plates disposed between the disk and the exhaust diffuser.

The exhaust diffuser assembly as in any preceding clause, wherein the at least one plate includes a first plate having a first thickness and a second plate having a second thickness, the second thickness being greater than the first thickness.

The exhaust diffuser assembly as in any preceding clause, wherein the at least one pin assembly comprises a plurality of pin assemblies arranged in an array on the exhaust diffuser, and wherein the plurality of pin assemblies includes at least one positioning pin assembly.

The exhaust diffuser assembly as in any preceding clause, wherein the positioning pin assembly includes an annular wall extending from the disk of the positioning pin assembly towards the exhaust diffuser to a free end, wherein the free end is spaced apart from the exhaust diffuser, and wherein the at least one plate contacts the annular wall of the positioning pin.

A vibrational damping assembly affixed to a turbomachine component, the vibrational damping assembly comprising: at least one pin assembly coupled to the turbomachine component, the at least one pin having a pin body and a disk coupled to the pin body; and at least one plate disposed between the disk and the turbomachine component, wherein the at least one plate surrounds the at least one pin, and wherein the at least one plate is movable between the disk and the turbomachine component relative to the at least one pin and relative to the turbomachine component to dampen vibrations experienced by the turbomachine component.

The vibrational damping assembly as in any preceding clause, wherein the at least one plate is thin walled such that the at least one plate defines a ratio between a thickness of the at least one plate and a width of the at least one plate of between about 1:100 and 1:5000.

The vibrational damping assembly as in any preceding clause, wherein the at least one plate comprises two or more plates disposed between the disk and the turbomachine component.

The vibrational damping assembly as in any preceding clause, wherein the at least one plate includes a first plate having a first thickness and a second plate having a second thickness, the second thickness being greater than the first thickness.

The vibrational damping assembly as in any preceding clause, wherein the at least one plate defines a plurality of apertures, and wherein each pin assembly of the at least one pin assembly extends through a respective aperture of the plurality of apertures.

The vibrational damping assembly as in any preceding clause, wherein the at least one pin assembly comprises a plurality of pin assemblies arranged in an array on the turbomachine component.

The vibrational damping assembly as in any preceding clause, wherein the plurality of pin assemblies includes at least one positioning pin assembly.

The vibrational damping assembly as in any preceding clause, wherein the positioning pin assembly includes an annular wall extending from the disk of the positioning pin assembly towards the turbomachine component to a free end, wherein the free end is spaced apart from the turbomachine component, and wherein the at least one plate contacts the annular wall of the positioning pin assembly.

The vibrational damping assembly as in any preceding clause, wherein the turbomachine component is an exhaust diffuser having an inner liner, an outer liner, and a plurality of struts, and wherein the vibrational damping assembly is affixed to at least one of the inner liner, the outer

What is claimed is:

1. An exhaust diffuser assembly for a turbomachine, the exhaust diffuser assembly comprising:
an exhaust diffuser having an inner liner, an outer liner spaced apart from the inner liner such that an exhaust flow passage is defined therebetween, and a plurality of struts disposed within the exhaust flow passage and extending between the inner liner and the outer liner; and
one or more vibrational damping assemblies affixed to the exhaust diffuser on at least one of the inner liner, the outer liner, and at least one strut of the plurality of struts, wherein each vibrational damping assembly of the plurality of vibrational damping assemblies includes:
at least one pin assembly coupled to the exhaust diffuser, the at least one pin assembly having a pin body and a disk coupled to the pin body; and
at least one plate disposed between the disk and the exhaust diffuser, wherein the at least one plate surrounds the at least one pin, and wherein the at least one plate is movable between the disk and the exhaust diffuser relative to the pin body and relative to the exhaust diffuser to dampen vibrations experienced by the exhaust diffuser.

2. The exhaust diffuser assembly as in claim 1, wherein the one or more vibrational damping assemblies include a plurality of vibrational damping assemblies circumferentially spaced apart from one another and affixed to at least one of the outer liner and the inner liner outside of the exhaust flow passage.

3. The exhaust diffuser assembly as in claim 2, wherein each strut of the plurality of struts defines an interior extending between an outer opening defined in the outer liner and an inner opening defined in the inner liner, wherein at least one vibrational damping assembly is affixed to the outer liner and is disposed between circumferentially neighboring outer openings, and wherein at least one vibrational damping assembly is affixed to the inner liner and is disposed between circumferentially neighboring inner openings.

4. The exhaust diffuser assembly as in claim 1, wherein the at least one plate comprises an outer plate and an inner plate.

5. The exhaust diffuser assembly as in claim 4, wherein the outer plate is offset from the inner plate such that the inner plate and the outer plate partially overlap.

6. The exhaust diffuser assembly as in claim 1, the plurality of vibrational damping assemblies include a first vibrational damping assembly and a second vibrational damping assembly neighboring one another, wherein the first vibrational damping assembly includes a first outer plate and a first inner plate, wherein the second vibrational damping assembly includes a second outer plate and a second inner plate, and wherein the first inner plate is offset from the first outer plate and contacts the first outer plate and the second outer plate.

7. The exhaust diffuser assembly as in claim 1, wherein the at least one plate is thin walled such that the at least one plate defines a ratio between a thickness of the at least one plate and a width of the at least one plate of between about 1:100 and 1:5000.

8. The exhaust diffuser assembly as in claim 1, wherein the at least one plate comprises two or more plates disposed between the disk and the exhaust diffuser.

9. The exhaust diffuser assembly as in claim 1, wherein the at least one plate includes a first plate having a first thickness and a second plate having a second thickness, the second thickness being greater than the first thickness.

10. The exhaust diffuser assembly as in claim 1, wherein the at least one pin assembly comprises a plurality of pin assemblies arranged in an array on the exhaust diffuser, and wherein the plurality of pin assemblies includes at least one positioning pin assembly.

11. The exhaust diffuser assembly as in claim 10, wherein the positioning pin assembly includes an annular wall extending from the disk of the positioning pin assembly towards the exhaust diffuser to a free end, wherein the free end is spaced apart from the exhaust diffuser, and wherein the at least one plate contacts the annular wall of the positioning pin.

12. A vibrational damping assembly affixed to a turbomachine component, the vibrational damping assembly comprising:
at least one pin assembly coupled to the turbomachine component, the at least one pin having a pin body and a disk coupled to the pin body; and
at least one plate disposed between the disk and the turbomachine component, wherein the at least one plate surrounds the at least one pin, and wherein the at least one plate is movable between the disk and the turbomachine component relative to the at least one pin and relative to the turbomachine component to dampen vibrations experienced by the turbomachine component.

13. The vibrational damping assembly as in claim 12, wherein the at least one plate is thin walled such that the at least one plate defines a ratio between a thickness of the at least one plate and a width of the at least one plate of between about 1:100 and 1:5000.

14. The vibrational damping assembly as in claim 12, wherein the at least one plate comprises two or more plates disposed between the disk and the turbomachine component.

15. The vibrational damping assembly as in claim 12, wherein the at least one plate includes a first plate having a first thickness and a second plate having a second thickness, the second thickness being greater than the first thickness.

16. The vibrational damping assembly as in claim 12, wherein the at least one plate defines a plurality of apertures, and wherein each pin assembly of the at least one pin assembly extends through a respective aperture of the plurality of apertures.

17. The vibrational damping assembly as in claim 12, wherein the at least one pin assembly comprises a plurality of pin assemblies arranged in an array on the turbomachine component.

18. The vibrational damping assembly as in claim 17, wherein the plurality of pin assemblies includes at least one positioning pin assembly.

19. The vibrational damping assembly as in claim 18, wherein the positioning pin assembly includes an annular wall extending from the disk of the positioning pin assembly towards the turbomachine component to a free end, wherein the free end is spaced apart from the turbomachine component, and wherein the at least one plate contacts the annular wall of the positioning pin assembly.

20. The vibrational damping assembly as in claim 12. wherein the turbomachine component is an exhaust diffuser having an inner liner, an outer liner, and a plurality of struts, and wherein the vibrational damping assembly is affixed to at least one of the inner liner, the outer liner. and one or more struts of the plurality of struts.
